(19) United States
(12) Patent Application Publication
(10) Pub. No.: US 2015/0358414 A1
(43) Pub. Date: Dec. 10, 2015

(54) Inference Based Event Notifications

(71) Applicant: Microsoft Corporation, Redmond, WA (US)

(72) Inventors: Sujeet Ramesh Mehta, Kirkland, WA (US); Jeffrey Jay Johnson, Bellevue, WA (US)

(21) Appl. No.: 14/301,089

(22) Filed: Jun. 10, 2014

(51) Int. Cl. H04L 29/08; G06Q 10/02; G06F 3/0484

(52) U.S. Cl. CPC H04L 67/22; G06F 3/0484; G06Q 10/02; G06Q 10/025

(57) ABSTRACT

Inference based event notification techniques are described. In one or more implementations, user preferences are inferred based on monitored interaction of the user with at least one computing device. One or more events are located that correspond to the inferred user preferences and are likely to be available to the user based on an examination of a calendar of the user that is performed automatically and without user intervention. An option is output in a user interface that is selectable by a user to obtain credentials to attend the located one or more events.

### BACKGROUND

Conventional event planning techniques are cumbersome. For example, a conventional event planning technique may begin with first figuring out that the event user is interested in what is happening at a particular location, followed by finding when the tickets are available and after that standing in an online queue to make sure preferred tickets are booked.

Each of these steps may include multiple tasks to be performed at specific times. Thus, planning for an event using these conventional techniques may become frustrating to the user, which may even lead to user to forgo the event and result in lost revenue opportunities for an event organizer as well as reduced user satisfaction.

### SUMMARY

Inference based event notification techniques are described. In one or more implementations, user preferences are inferred based on monitored interaction of the user with at least one computing device. One or more events are located that correspond to the inferred user preferences and are likely to be available to the user based on an examination of a calendar of the user that is performed automatically and without user intervention. An option is output in a user interface that is selectable by a user to obtain credentials to attend the located one or more events.

In one or more implementations, one or more inputs are received by one or more computing devices indicating a likely intent of a user to attend a reoccurring event. Responsive to the receiving, iteratively requests for permission are performed by the one or more computing devices to attend successive instances of the reoccurring event until the requested permission for at least one of the instances is received or a predefined stopping criterion is reached. A notification is caused to be output in a user interface by the one or more computing devices indicating at least one result of the iterative requests.

In one or more implementations, a system includes one or more modules implemented at least partially in hardware. The one or more modules are configured to perform operations that include inferring user preferences based on monitored interaction of the user with at least one computing device, locating one or more events that correspond to the inferred user preferences and are likely to be available to the user based on an examination of a calendar of the user that is performed automatically and without user intervention, the examination including a determination of a likely importance of at least one event in the calendar to a user, and responsive to a determination that the likely importance of the one or more events in the calendar is less that the located one or more events, outputting an option in a user interface that is selectable by a user to obtain credentials to attend the located one or more events.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform inference based event notification techniques.

FIGS. 2 and 3 describe an example system and procedure, respectively, in which a digital assistant is used to aid planning to attend an event based on one or more inferences.

FIGS. 4 and 5 describe an example system and procedure, respectively, in which a digital assistant is used to make iterative requests to a reoccurring event.

FIGS. 6 and 7 describe an example system and procedure, respectively, in which a digital assistant is used in a determination of a likely importance of an event in a user's calendar, which is utilized at least in part to determine availability of a user for another event.

FIG. 8 illustrates an example system including various components of an example device that can be implemented as any type of computing device as described with reference to FIGS. 1-7 to implement embodiments of the techniques described herein.

### DETAILED DESCRIPTION

Overview

Conventional event attendance techniques are cumbersome as each part in the process may involve multiple steps that are manually performed by the user. This may include determining if there is an event of interest, geographic locations of the event, when credentials may be made available for the event, cost and locations for the credentials, user availability for the event as well as availability of other users to attend the event, and so forth. Consequently, users are often unaware of events and even forgo attendance of the event when aware due to these complications.

Inference based event notification techniques are described. In one or more implementations, inferences are made by a personal digital assistant as to likely user preferences based on user interaction with one or more computing devices. This may include monitoring a type of content consumed using the device, an examination of explicitly mentioned interests (e.g., via social network site, email, text messages), and so forth.

These inferences may then serve as a basis to locate likely events of interest, such as concerts, spoken word events, lectures, dinner reservations, and so on. As a part of this location, knowledge of a user's calendar may be leveraged, which may include a determination of where and when a user is available as well as a likely importance of the events to the user, e.g., a birthday party versus another dinner reservation as indicated by text associated with the events in the user's calendar.

A variety of other functionality may be included as part of the personal digital assistant. This may include support of repeated requests for reoccurring events (e.g., for reservations to a restaurant that books 6 months out), options to support an automatic purchase, functionality to check other users' calendars, suggestions based on identified user travel, automatic calendar updates, and so on. In this way, the personal digital assistant may support functionality to overcome the limitations of conventional event related techniques, further description of which is included in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

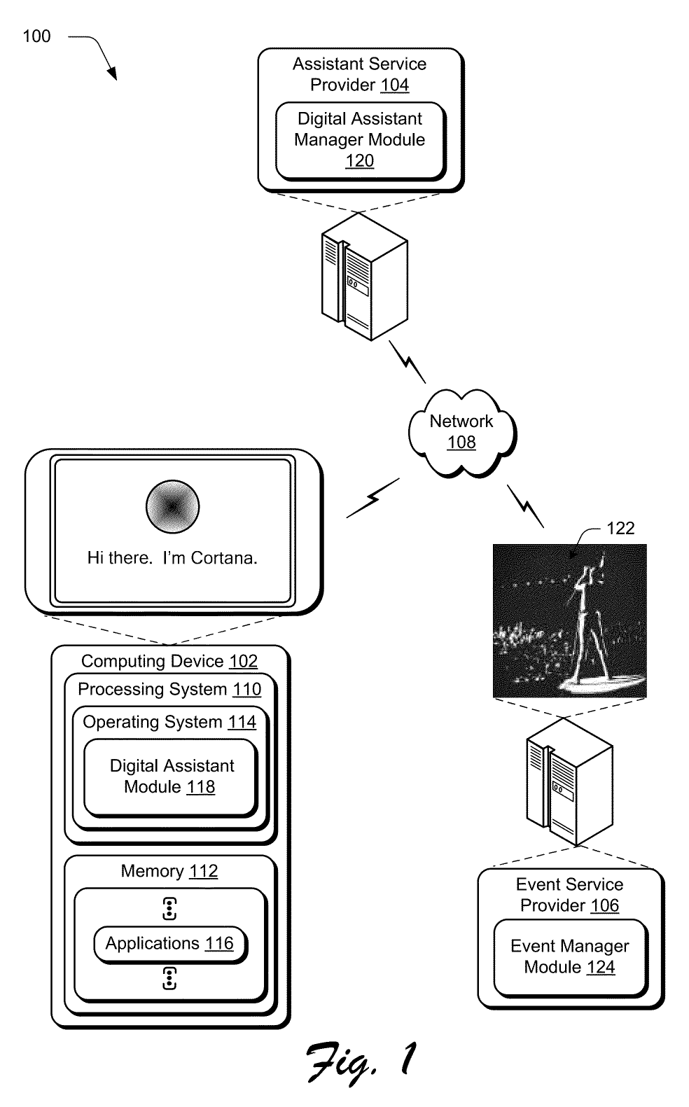

FIG. 1 is an illustration of an environment 100 in an example implementation that is operable to employ techniques described herein. The illustrated environment 100 includes a computing device 102, an assistant service provider 104, and an event service provider 106 that are communicatively coupled, one to another, via a network 108. The computing device 102 as well as computing devices that may implement the assistant service provider 104 and the event service provider 106 may be configured in a variety of ways.

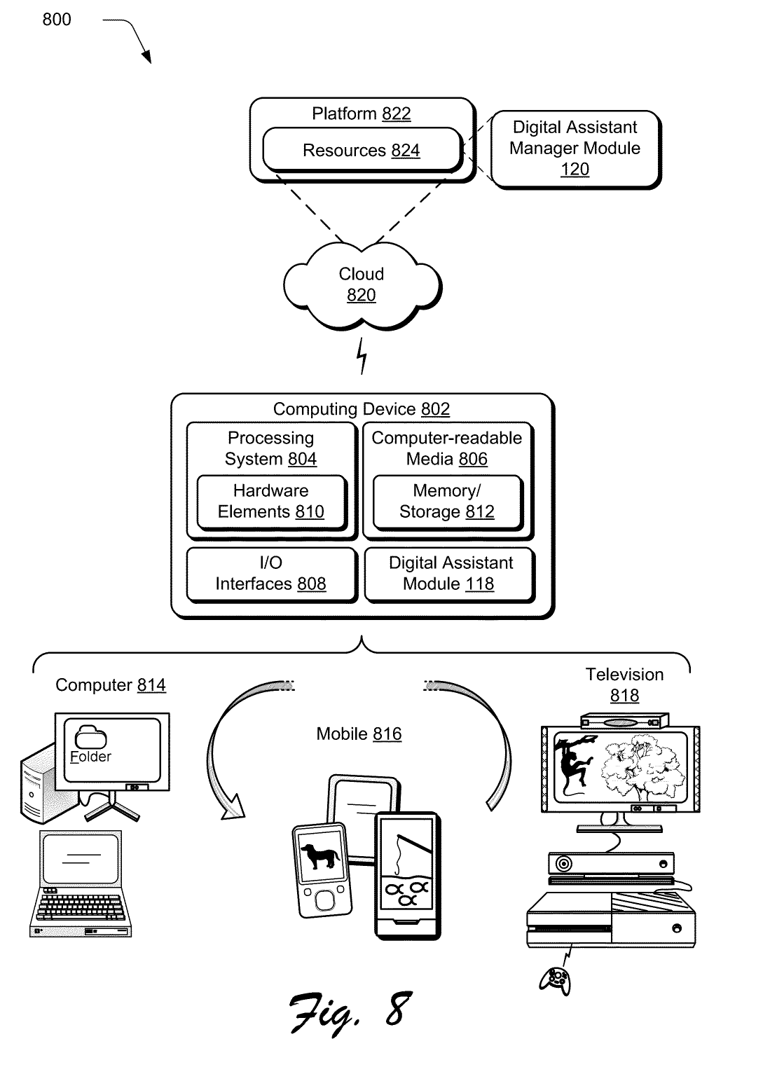

For example, a computing device may be configured as a computer that is capable of communicating over the network 108, such as a desktop computer, a mobile station, an entertainment appliance, a set-top box communicatively coupled to a display device, a wireless phone, a game console, and so forth. Thus, the computing devices may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown, the computing devices may be representative of a plurality of different devices, such as multiple servers utilized by a business to perform operations such as by the service provider, a remote control and set-top box combination, an image capture device and a game console configured to capture gestures, and so on. Further discussion of computing device configurations and support of “in the cloud” functionality may be found in relation to FIG. 8.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The computing device 102 in this example includes a processing system 110 that may include one or more processors (e.g., CPUs) and an example of a computer readable storage media, illustrated as memory 112. The computing device 102 is further illustrated as including an operating system 114. The operating system 114 is configured to abstract underlying functionality of the computing device 102 to applications 116 that are executable on the computing device 102. For example, the operating system 114 may abstract processing, memory, network, and/or display functionality of the computing device 102 such that the applications 116 may be written without knowing “how” this underlying functionality is implemented. The application 116, for instance, may provide data to the operating system 114 to be rendered and displayed by a display device without understanding how this rendering will be performed. The operating system 114 may also represent a variety of other functionality, such as to manage a file system and user interface that is navigable by a user of the computing device 102.

The operating system 108 is also illustrated as including a digital assistant module 118. The digital assistant module 118 is representative of functionality to navigate knowledge and perform tasks similar to a personal assistant on behalf of a user, but may do so automatically and without user intervention. Thus, the digital assistant module 118 may implement a form of article intelligence to perform tasks on behalf of a user, e.g., through receiving inputs such as gestures, text, natural language inputs, and so on.

Although illustrated as being implemented on the computing device 102, functionality represented by the digital assistant module 118 may also be implemented in whole or in part via the network 108, such as through use of a digital assistant manager module 120 by the assistant service provider 104. The digital assistant manager module 120, for instance, may be representative of functionality to manage a plurality of different digital assistants. Further, this management may be done even when the computing device 102 is unavailable, e.g., inoperable due to insufficient power, turned off, and so on. Thus, the digital assistant manager module 120 may be utilized to support implementation of the digital assistant while reducing resource consumption on the part of the computing device 102 that supports direct user interaction. Therefore, the following discussion may described examples of implementation of the digital assistant on the computing device 102 and/or via the assistant service provider 104.

Regardless of how and where implemented, the digital assistant may be utilized to support a variety of different functionality. One example of this functionality involves attendance by a user of the computing device 102 to an event 122. An event 122 may take a variety of different forms, such as a concert, sporting event, symphony, play, dinner reservation, golf tee time, and so forth. As previously described, however, conventional techniques may make it difficult for a user to be made aware of an event as well as plan to attend the event. Accordingly, the digital assistant module 118 may include functionality to aid a user in overcoming these conventional limitations.

For example, the digital assistant module 118 may have access to information describing a user's interaction with a music store, calendar, explicitly stated interests, as well as the user's current location. Using this information, the digital assistant module 118 can infer user preferences.

Once the user preferences are inferred, this information may be gathered by the digital assistant manager module 120 to perform event tracking for those events 122, e.g., through interaction with an event manager module 124 of an event service provider 106 associated with the event 122. In this way, as soon as the event is published, the user is notified by the digital assistant module 118 as to the availability of the event, which may also include providing an option in the notification to obtain credentials (e.g., tickets), to attend the event.

After that, there is no user intervention, but rather the digital assistant manager module 120 may create a digital assistant “in the cloud” that “wakes up” at the time ticketing for the event 122 is open by the event manager module 124. The digital assistant manager module 120 may even leverage the user's account info (e.g., credit card details) to complete the reservation with the ticketing site at which point it informs the user of their confirmed event booking. In one or more implementations, the digital assistant manager module 120 may also attempt to book attendance to the event 122 using a variety of different event service providers 106, which may support increased robustness. Also, since the digital assistant manager module 120 has access to user's calendar as well as location, the digital assistant may help plan ancillary services, e.g., for transport, dining options before the event, and so on. Examples of functionality of the digital assistant that may be employed as part of planning attendance to an event may be found in the following discussion.

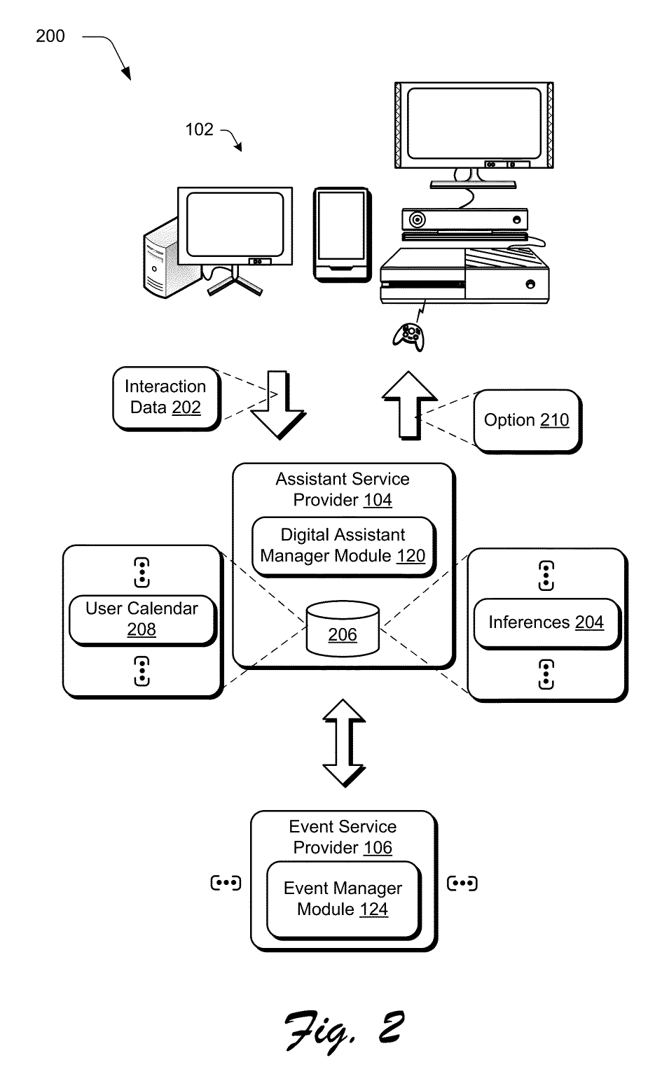

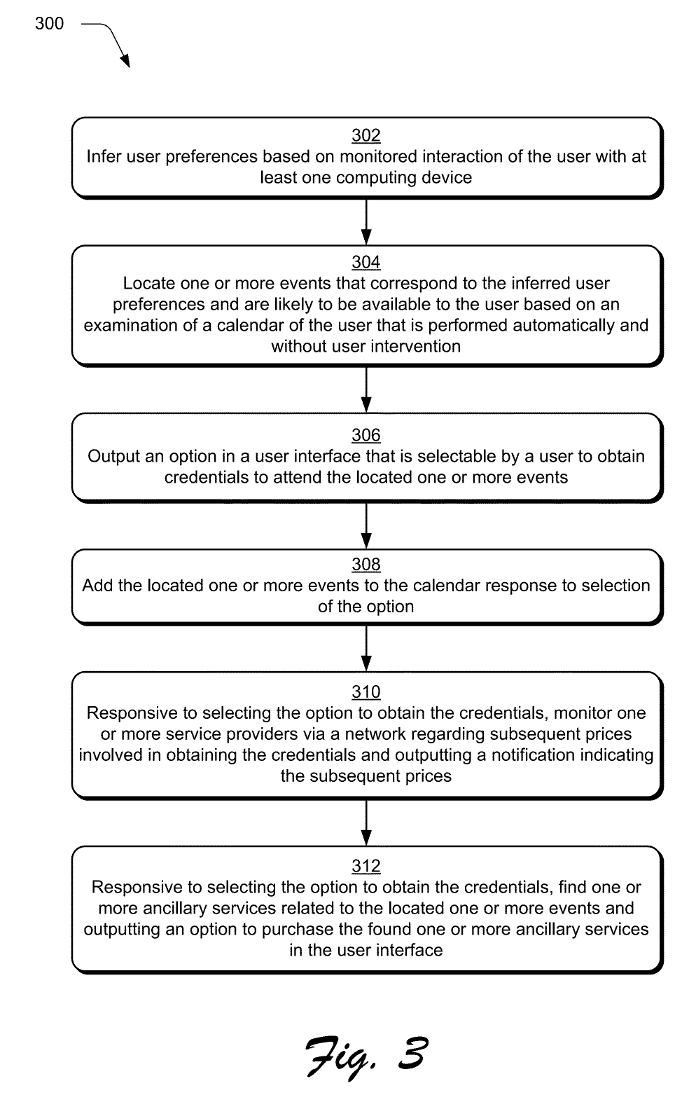

FIGS. 2 and 3 describe an example system 200 and procedure 300, respectively, in which a digital assistant is used to aid planning to attend an event based on one or more inferences. FIG. 3 is a flow diagram that describes steps in a procedure in accordance with one or more embodiments. The procedure can be performed in connection with any suitable hardware, software, firmware, or combination thereof. In at least some embodiments, the procedure is performed, at least in part, by suitably-configured modules, such as digital assistant module 118 and/or digital assistant manager module 120. As such, the following discussion refers to both FIGS. 2 and 3 in the description of this example functionality.

The system 200 includes an assistant service provider 104 having a digital assistant manager module 120 as previously described. The computing device 102 in this instance is illustrated as assuming a variety of different forms, such as a desktop PC, a mobile device, and a game console as previously described, further examples of which may be found in relation to FIG. 8. Each of these devices may be associated with a user, e.g., a common user account, and thus interaction data 202 may be collected from each of these devices that describes interactions that are performed by a user with the respective devices.

The interaction data 202 may described a variety of different interactions. For example, the interaction data 202 may describe content, with which, a user has interacted such as movies, music, books, or other media. The interaction data 202 may also include information parsed from other content of a user, such as emails, texts, social network services, and so on. For example, the interaction data 202 may be received from accounts associated with the user, such as a social networking site, email, instant messaging, text messaging, and so on. This interaction data 202 may be processed to determine explicit mentions of interests of a user, e.g., “I love Band X,” “Restaurant Y is my favorite,” a “like” for a particular webpage of a business, and so on.

The digital assistant manager module 120 may then process this interaction data 202, regardless of source, to infer user preferences based on monitored interaction of the user with at least one computing device (block 302). An example of this is shown as inferences 204 that are stored in storage of the assistant service provider 104. The inferences 204 may also include inferences obtained from a user calendar 208, such as an indication of where and when a user will be located, e.g., for a business trip, a vacation, the user is “home,” and so forth.

The digital assistant manager module 120 may then locate one or more events that correspond to the inferred user preferences and are likely to be available to the user based on an examination of a calendar of the user, which is performed automatically and without user intervention (block 304). For example, the digital assistant manager module 120 may then leverage these inferences 204 to find events of interest through interaction with one or more event service providers 106.

Once an event is found, the digital assistant manager module 120 may then leverage the user calendar to determine whether the user is likely available for the found event. A user, for instance, may be traveling for business to a particular geographic location at which an event is scheduled to occur and thus the digital assistant manager module 120 may make a determination that the user is available for the event. A determination of the user's travel may be inferred from the user's calendar (e.g., scheduled air travel), indicated in text processed from emails, a status update (e.g., “I'm going to Cabo”), and so forth.

The digital assistant manager module 120 may also leverage one or more calendars of other users in making the determination of availability. A user, for instance, may indicate a spouse, friends, coworkers, family members, and so on and obtain permissions to access calendars associated with these other users. Therefore, the determination of availability may be performed for the user as well as other associated users.

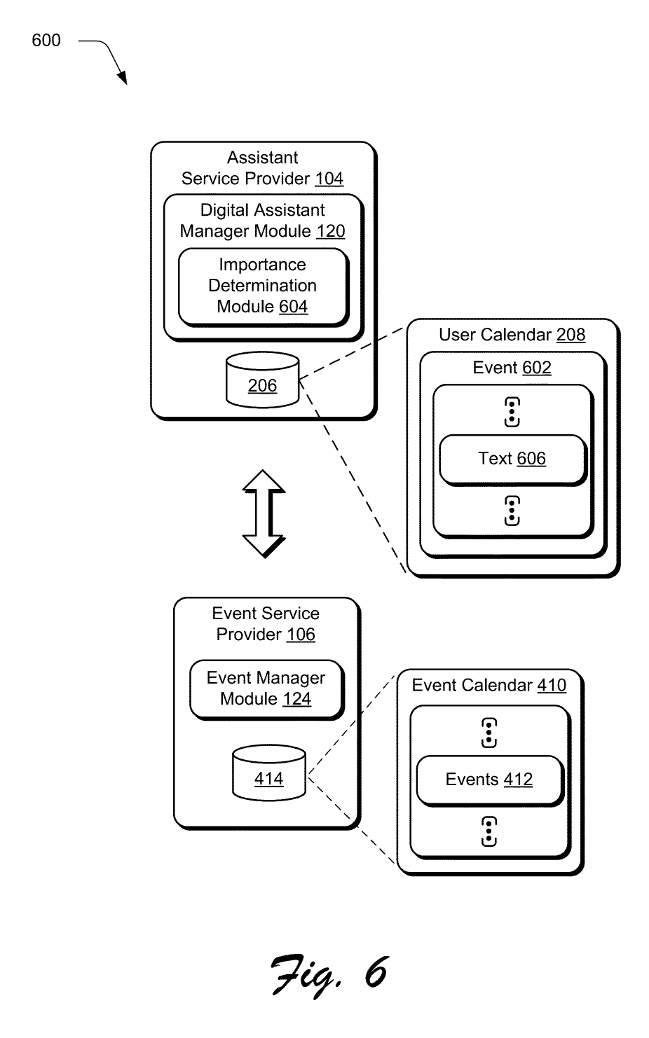

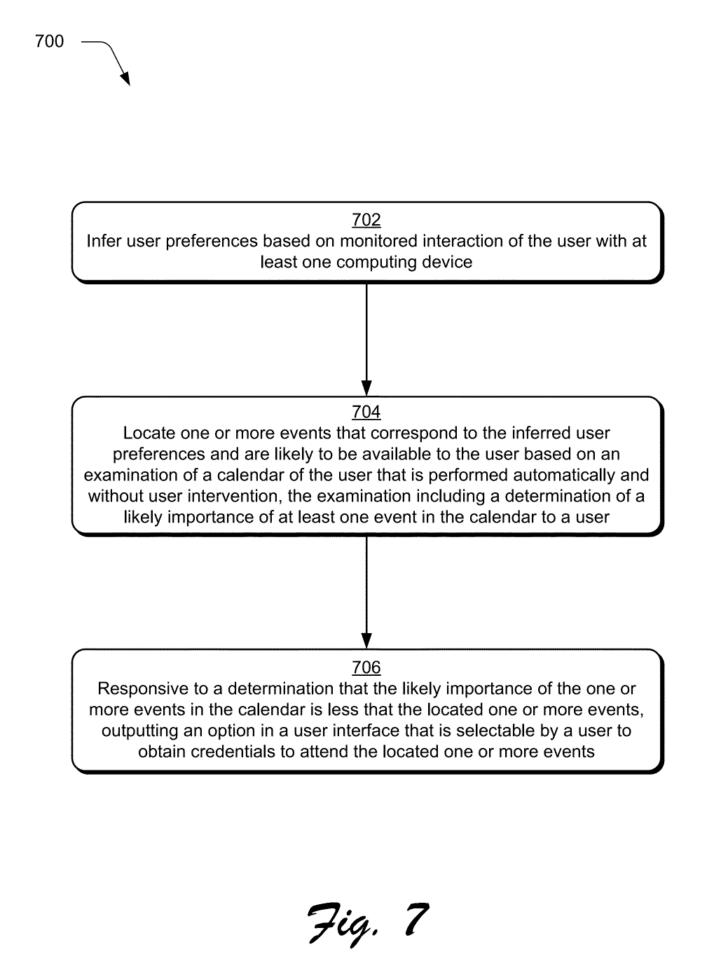

The determination of which other users to be included may be made responsive to a manual indication by the user, and once obtained, may also leverage inferences obtained from the users, e.g., in a manner similar to the interaction data 202 as described above. The other users may also be inferred, such as based on data obtained from a social network service (e.g., mentions of similar likes), explicit indications, and so on as previously described. In this way, the digital assistant manager module 120 may suggest other attendees for an event as well as the event itself. Other examples are also contemplated, such as to determine a likely importance of a previously scheduled event to the user, an example of which is described in relation to FIGS. 6 and 7.

Once a located event has been found and is available based on the user calendar, an option 210 is output in a user interface that is selectable by a user to obtain credentials to attend the located one or more events (block 306). The digital assistant manager module 120, for instance, may form a communication that is communicated via the network 108 of FIG. 1 that includes the option 210. The option is selectable by a user to obtain the credentials, e.g., confirm a dinner reservation, buy a ticket, and so on, through selecting the option 210.

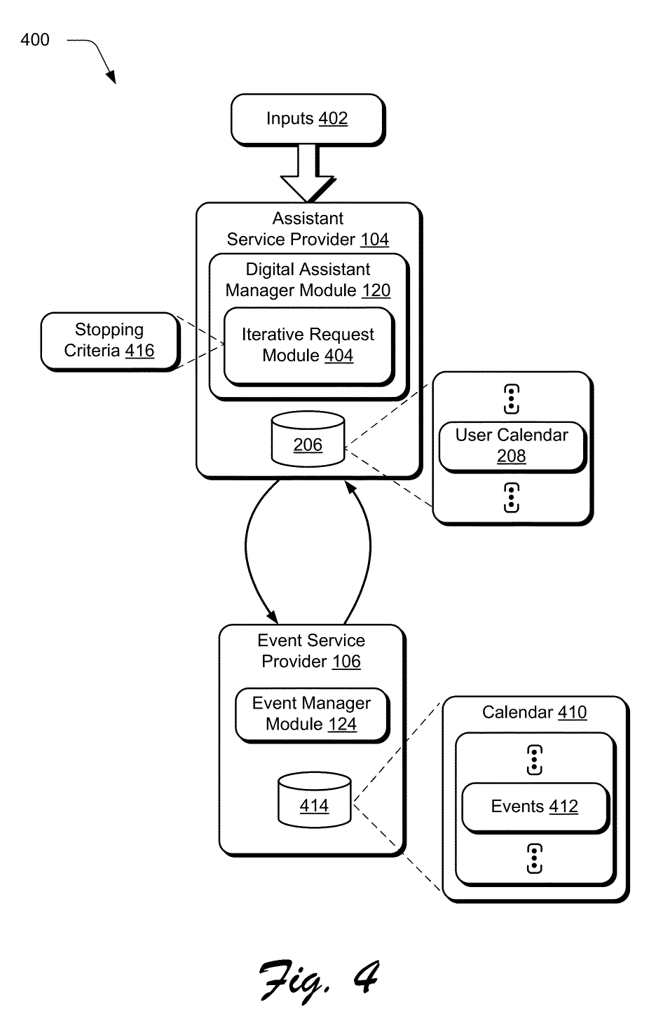

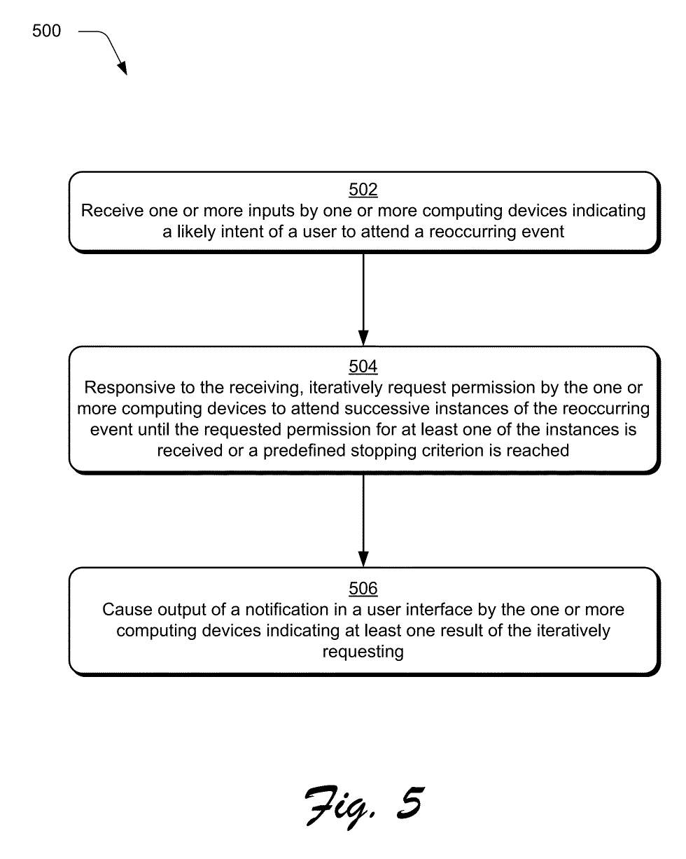

In this way, a user may be informed as to availability of an event and be provided with an option 210 to obtain credentials to attend that event. Thus, the location, availability, and ability to attend may be performed “behind the scenes” by the digital assistant and enable a user to efficiently decide whether to attend the event. Selection of the option 210 may cause the event to be automatically included in the user calendar 208 (block 308) and even other users following the example of other attendees above. Other examples are also contemplated, such as to support an automatic acceptance, an example of which is described in relation to FIGS. 4 and 5.

Responsive to selecting the option to obtain the credentials, one or more service providers may be monitored via the network regarding subsequent prices involved in obtaining the credentials and a notification may be output indicating the subsequent prices (block 310). For example, a user may obtain credentials (e.g., a ticket) to attend the event 122. The digital assistant manager module 120 may be configured to track subsequent prices for the ticket, e.g., such as on third party websites, to determine whether the cost for the ticket has increased, such as over a threshold amount which may be defined as a percentage, set dollar amount, and so forth.

If so, the notification may be output indicating that the ticket may be resold and examples of those higher prices. The notification may include an option to make the ticket available for sale. Other examples are also contemplated without departing from the spirit and scope thereof.

Additionally, responsive to selecting the option to obtain the credentials one or more ancillary services related to the located one or more events may be found and an option to purchase the found one or more ancillary service may be output in the user interface (block 312). For example, the digital assistant manager module 120 may also leverage the inferences 204 to determine ancillary services that may be desirable by the user, e.g., such as transportation (e.g., a car service), dining (e.g., restaurant to eat at before a concert), and so forth. These inferences, like the other, may be based on a variety of different sources, such as a user's calendar 208, based on interaction data 202, and so on.

FIGS. 4 and 5 describe an example system 400 and procedure 500, respectively, in which a digital assistant is used to make iterative requests to a reoccurring event. FIG. 5 is a flow diagram that describes steps in a procedure in accordance with one or more embodiments. The procedure can be performed in connection with any suitable hardware, software, firmware, or combination thereof. In at least some embodiments, the procedure is performed, at least in part, by suitably-configured modules, such as digital assistant module 118 and/or digital assistant manager module 120. As such, the following discussion refers to both FIGS. 4 and 5 in the description of this example functionality.

The system 400 includes an assistant service provider 104 having a digital assistant manager module 120, as well as a user calendar 208 available via storage 206 as previously described. In some instances, events may be reoccurring in nature in that availability of the event repeats on a regular temporal basis and may even do so at a particular location. For example, a popular restaurant may “open its reservations” so that reservations are made available daily at a defined interval of time, e.g., six months out. Conventional techniques, however, typically involved a “one and done” approach in which a request was made and if denied, no other requests were made.

Accordingly, one or more inputs may be received by one or more computing devices indicating a likely intent of a user to attend a reoccurring event (block 502). As illustrated, for instance, the inputs 402 may be received by the digital assistant manager module 120. The inputs 402 may take a variety of forms, such as manually specified by a user through interaction with a user interface, inferred as described in relation to FIGS. 2 and 3, and so on.

The digital assistant manager module 120 is illustrated as including an iterative request module 404. The iterative request module 404 is representative of functionality to make iterative requests to obtain credentials for an event. This may be for a reoccurring event as previously described as well as for a single event, e.g., to make repeated requests to get tickets to a concert.

The iterative request module 404 may then communicate with the event service provider 106 associated with the event to obtain credentials to the event as previously described. For example, the event manager module 124 may manage a calendar 410 of events 412, which is illustrated as available via storage 414. These events 412 may be reoccurring in that the events are available at different times, e.g., different successive days for dinner reservations, different weeks for a sporting event, and so on.

Thus, responsive to the receiving of the inputs, the iterative request module 404 may iteratively request permission to attend successive instances of the reoccurring event until the request permission for at least one of the instances is received or a predefined stopping criterion is reached (block 504). In this way, the iterative request module 404 may make these requests “outside” of the event service provider 106 and thus support this functionality even if iterative requests are not supported by the event service provider 106 itself

The iterative request module 404 may also support stopping criteria 416 such that the requests do not continue indefinitely. This may include specifying a date range such that when events are no longer available in that range the iterative requests are stopped, a maximum price to spend, locations of particular seats at an event, a time range of a day (e.g., dinner between 5-9 μm), and so forth.

Output of a notification is a user interface is then caused that indicates at least one result of the iterative requests (block 506). The notification, for instance, may describe successful completion, describe a stopping criterion that was met that caused the iterative requests to cease being made, and so forth. Thus, in this example a business-to-business communication technique may be employed without consuming resources of a computing device 102 of the user and without a user directly involved in each iterative request. Other iterative examples may involve requests for tickets to a particular event that is not reoccurring, e.g., a concert, when a previous request is denied.

The inputs 402 may also specify an option to enable the credentials to the event to be obtained automatically without further user input, i.e., without “checking” with the user. For example, a user may specify an amount the user is willing to pay, a specific timeframe (e.g., range of dates), and so on. If an event is found that complies with the specified requirements, the digital assistant manager module 120 may obtain (e.g., purchase) the credentials. This criteria may be set for a particular event, particular type of event (e.g., home football game), and so forth.

FIGS. 6 and 7 describe an example system 600 and procedure 700, respectively, in which a digital assistant is used a determination of a likely importance of an event in a user's calendar is utilized at least in part to determine availability of a user for another event. FIG. 7 is a flow diagram that describes steps in a procedure in accordance with one or more embodiments. The procedure can be performed in connection with any suitable hardware, software, firmware, or combination thereof. In at least some embodiments, the procedure is performed, at least in part, by suitably-configured modules, such as digital assistant module 118 and/or digital assistant manager module 120. As such, the following discussion refers to both FIGS. 6 and 7 in the description of this example functionality.

The system 600 includes an assistant service provider 104 having a digital assistant manager module 120, as well as a user calendar 208 that is available via storage 206 as previously described. In some instances, a digital assistant manager module 120 may locate events 412 from an event service provider 106 that may be of interest to a user. However, these events 412 may conflict with events 602 in the user's calendar 208. Accordingly, the digital assistant manager module 120 may leverage an importance determination module 604 that is representative of functionality to determine a relative importance of an event 602 in a user's calendar 208 in making a suggestion of an available event from an event service provider 106.

For example, user preferences may be inferred based on monitored interaction of the user with at least one computing device (block 702) as previously described in relation to FIGS. 2 and 3. One or more events are located that correspond to the inferred user preferences and are likely to be available to the user based on an examination of a calendar of the user that is performed automatically and without user intervention, the examination including a determination of a likely importance of at least one event in the calendar to a user (block 704).

The importance determination module 602, for instance, may examine text 606 associated with the event 602 in the user calendar 208 that conflicts with a located event 412 in an event calendar 410. The text 606 may include keywords that are indicative of a likely importance of the event 602, such as a birthday, anniversary, whether the event is reoccurring (e.g., within a short timeframe of less than a year and thus likely of less interest), work-related function (which may be assigned a high or low level of importance by a user), a sporting event in which the user participates (e.g., a golf event), a personal grooming appointment (e.g., a haircut appointment), and so on. From this examination, the importance determination module 604 may determine how likely participation in that particular event 602 is to the user. For instance, a user may easily reschedule a haircut appointment and thus may be skipped but a kid's birthday is not to be missed for any reason.

Further, this determination of importance may also include a determining a likely importance of attending the located event, e.g., a favorite artist versus a difficult to obtain dinner reservation. In this way, the relative levels of importance may then be compared to determine whether to notify a user as to the located event 412.

Responsive to a determination that the likely importance of the one or more events in the calendar is less that the located one or more events, an option is output in a user interface that is selectable by a user to obtain credentials to attend the located one or more events (block 706). Like before, the option may be selected to obtain the credentials without further user input. Further, this option may also include a notification as to the conflicting event 602 in the user's calendar 208, which may include functionality to reschedule the conflicting event 602, cancel the event, and so on. A variety of other examples are also contemplated without departing from the spirit and scope thereof.

Example System and Device

FIG. 8 illustrates an example system generally at 800 that includes an example computing device 802 that is representative of one or more computing systems and/or devices that may implement the various techniques described herein. This is illustrated through inclusion of the digital assistant module 118 and digital assistant manager module 120 as described in the previous sections. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method implemented by one or more computing devices, the method comprising:
inferring user preferences based on monitored interaction of the user with at least one computing device;
locating one or more events that correspond to the inferred user preferences and are likely to be available to the user based on an examination of a calendar of the user that is performed automatically and without user intervention; and
outputting an option in a user interface that is selectable by a user to obtain credentials to attend the located one or more events.

2. A method as described in claim 1, wherein the monitored interaction of the user includes identifying particular content, with which, the user has interacted.

3. A method as described in claim 1, wherein the monitored interaction of the user includes identifying explicitly mentioned interests of the user.

4. A method as described in claim 3, wherein the explicitly mentioned interests of the user are taken, automatically and without user intervention, from textual mentions in email, instant messaging, status updates or text messages, or indications made via a social network service.

5. A method as described in claim 1, wherein the likely availability based on the examination of the calendar is based at least in part on a determination of a likely importance of at least one event scheduled on the calendar.

6. A method as described in claim 5, wherein the likely importance is performed by analyzing text included as part of the at least one event in the calendar.

7. A method as described in claim 1, wherein the likely availability based on the examination of the calendar is based at least in part on a determination of likely location of a user in relation to the one or more events.

8. A method as described in claim 1, wherein the likely availability based on the examination of at least one other calendar associated with a different user.

9. A method as described in claim 1, further comprising adding the located one or more events to the calendar response to selection of the option.

10. A method as described in claim 1, further comprising responsive to selecting the option to obtain the credentials, monitoring one or more service providers via a network regarding subsequent prices involved in obtaining the credentials and outputting a notification indicating the subsequent prices.

11. A method as described in claim 1, further comprising responsive to selecting the option to obtain the credentials, finding one or more ancillary services related to the located one or more events and outputting an option to purchase the found one or more ancillary services in the user interface.

12. A method comprising:
receiving one or more inputs by one or more computing devices indicating a likely intent of a user to attend a reoccurring event;
responsive to the receiving, iteratively requesting permission by the one or more computing devices to attend successive instances of the reoccurring event until the requested permission for at least one of the instances is received or a predefined stopping criterion is reached; and
causing output of a notification in a user interface by the one or more computing devices indicating at least one result of the iteratively requesting.

13. A method as described in claim 12, wherein the successive instances of the reoccurring event occur on:
different times of day; or
different days of a week, month, or year.

14. A method as described in claim 12, wherein the predefined stopping criterion defines a period of time.

15. A method as described in claim 12, wherein the predefined stopping criterion defines a location associated with the reoccurring event at which the user is likely to be located as indicated by a calendar of the user.

16. A method as described in claim 12, wherein the permission is configured as a reservation for a particular time to attend the instance of the reoccurring event.

17. A method as described in claim 12, wherein the one or more inputs are inferred based on monitored interaction of the user with at least one computing device.

18. A method as described in claim 17, wherein the monitored interaction of the user includes identifying explicitly mentioned interests of the user are taken, automatically and without user intervention, from textual mentions in email, instant messaging, status updates or text messages, or indications made via a social network service.

19. A system comprising;
one or more modules implemented at least partially in hardware, the one or more modules configured to perform operations comprising:
inferring user preferences based on monitored interaction of the user with at least one computing device;
locating one or more events that correspond to the inferred user preferences and are likely to be available to the user based on an examination of a calendar of the user that is performed automatically and without user intervention, the examination including a determination of a likely importance of at least one event in the calendar to a user; and
responsive to a determination that the likely importance of the one or more events in the calendar is less that the located one or more events, outputting an option in a user interface that is selectable by a user to obtain credentials to attend the located one or more events.

20. A system as described in claim 19, wherein the inferring is performed iteratively to update the user preferences.
